(19) United States
(12) Patent Application Publication
(10) Pub. No.: US 2012/0165007 A1
(43) Pub. Date: Jun. 28, 2012

(54) TRUNKING PROTOCOL FOR MULTI-CHANNEL TWO-WAY RADIO COMMUNICATION NETWORK

(75) Inventor: Daniel A. Martin, Buenos Aires (AR)

(73) Assignee: RANGER ELECTRONIC COMMUNICATIONS, INC., Taipei Hsien (TW)

(21) Appl. No.: 12/976,860

(22) Filed: Dec. 22, 2010

(51) Int. Cl. H04W 84/08

(52) U.S. Cl. 455/426.1

(57) ABSTRACT

A trunking protocol for a two-way radio communication system designates an available channel as a parking channel for radios on standby. The parking channel is converted to an active voice channel upon request for a voice call, and non-called radios are then moved from the newly-designated voice channel to a newly-designated parking channel. Upon completion of the voice call, the participating radios are moved to the then-existing parking channel, and the channel of the just-completed voice call becomes available. If all channels are busy such that no parking channel is available, the radios in standby mode convert to operate in scan mode until a channel becomes available to serve as the parking channel.

### FIELD OF THE INVENTION

The invention relates to trunking protocols for channel acquisition on a multi-channel two-way radio communication network.

### BACKGROUND

“Trunking” is a term used in the telecommunications industry to describe the process of selecting a clear communication channel on a given network from multiple available channels on the network. In a conventional multi-channel two-way radio communication system, a user typically has access to only a single channel, so the user must monitor the channel and wait until the channel is clear to make a call. But in trunking systems, when a user initiates a call, the trunking system electronically monitors each channel and selects one clear (unused) channel from many possible channels. Trunking takes advantage of the fact that typically not all users sharing a communications network require access to the network at any given time, so the number of lines required to service all users is typically less than the total number of users. Both analog and digital trunking protocols are known, but analog protocols are no longer widely used due to their low efficiency compared to digital protocols. Known digital protocols exist either with a control channel or without a control channel. Trunking networks have applications in many industries, including real estate management, industrial complexes, transportation operations (such as limousines, taxis, shuttles), and rural police and fire.

FIG. 1 and FIG. 2 are diagrams illustrating how radios 20 (RAD₁, RAD₂, RAD₃, RAD₄, RAD₅, . . . RADₙ) are assigned to channels in a typical control channel digital trunking system 5. One or more trunking controllers 10 (TC₁, TC₂, TC₃, . . . TCₙ) control one or more corresponding repeaters 15 (RPT₁, RPT₂, RPT₃, . . . RPTₙ). Each trunking controller+repeater pair represents a repeater channel (RC₁, RC₂, RC₃, . . . RCₙ). One of the repeater channels serves as a control channel, which in FIG. 1 and FIG. 2 is shown as RC₂. Data is continuously transmitted from the control channel RC₂ to the subscriber radios 20, as indicated by solid arrows 30.

When a subscriber radio initiates a call, data is exchanged between the radio and the control channel RC₂ so a voice channel may be assigned. Presuming the call is authorized, all called radios are ordered by the control channel RC₂ to jump to the assigned voice channel. For example, radio RAD₁ may initiate a call to radios RAD₂ and RAD₄ by sending a request to the control channel RC₂, which then forces all three radios (RAD₁, RAD₂ and RAD₄) to an available channel such as RC₃, as shown in FIG. 2. When the call ends, the participating radios (RAD₁, RAD₂ and RAD₄) all return to the control channel RC₂. The state of the system would then again be the same as shown in FIG. 1, presuming no other intervening calls. While this type of control channel digital trunking system is high-speed and very efficient for large numbers of subscribers, this system is expensive and requires one channel to be dedicated as a control channel, thus effectively blocking off that channel from being used for calls.

In a typical digital trunking system without using a control channel, all subscribers continuously scan all channels, and when an authorized call is initiated, all called radios stop scanning to remain on the selected channel, while other radios continue scanning the remaining channels. When the call ends, the participating radios begin scanning as before, and the selected channel becomes available for a new voice call. This type of scanning digital trunking system does not require a dedicated control channel, but this type of scanning system is lower-speed (i.e., higher channel acquisition time) compared to the control channel system.

Thus, a new trunking system is desirable that is low cost like analog systems, high speed like a digital control channel system, but like the scanning digital system has no dedicated control channel.

### SUMMARY

In one aspect of the invention, a multi-channel two-way radio communication network is used by designating an available channel in the network to be a parking channel, identifying the radios in the network that are in standby mode, and assigning the radios to the parking channel. When a request is received from one of the radios to initiate a conversation between the requesting radio and at least one other radio, the parking channel is reserved and designated as an active voice channel for the requested conversation, and a then-available channel in the network is designated as the new parking channel. The radios not participating in the conversation (or in any other conversation) are assigned to the new parking channel and remain in standby mode. When the conversation ends, the radios that were participating in the conversation are assigned to the then-existing parking channel, to wait on standby with the other radios assigned to the parking channel.

If another radio in the network requests a second conversation while the first conversation is still active, the then-existing parking channel is reserved and designated as another active voice channel for the second conversation, and once again a then-available channel in the network is designated as the new parking channel. And once again, the radios not participating in the second conversation (or in any other conversation) remain in standby mode and are assigned to the new parking channel. When the second conversation ends, the radios that were participating in the second conversation are likewise assigned to the then-existing parking channel, to wait on standby with the other radios assigned to the parking channel.

The above process is repeated as needed with each new conversation, such that the then-existing parking channel at the time the new conversation is initiated becomes the active voice channel for such new conversation, and a then-available channel is designated as the new parking channel for all standby radios to be assigned to. When a conversation ends on a specific channel, the participating radios are reassigned in standby mode to the then-existing parking channel, freeing up the specific channel to make it available for a new conversation. If a conversation is initiated that requires use of the last available channel (e.g., the then-existing parking channel), the remaining radios are converted to scan mode until a channel becomes available and is designated as the new parking channel, at which time the remaining radios will be converted back to standby mode and be assigned to the new parking channel. This will occur, for example, if there are n−1 active voice channels in a network with n channels, where n is greater than or equal to 1, and the nth conversation is then initiated.

### BRIEF DESCRIPTION OF THE DRAWINGS

The foregoing and other aspects of embodiments are described in further detail with reference to the accompanying drawings, wherein:

FIG. 1 is a diagram illustrating radios in standby mode in a PRIOR ART communication system using a typical digital trunking protocol with a control channel;

FIG. 2 is a diagram illustrating the radios of FIG. 1 assigned to respective channels after a request has been received to initiate a voice call between radios RAD₁, RAD₂, and RAD₄;

FIG. 3 is a diagram illustrating radios in standby mode in a communication system using a trunking protocol with a parking channel in accordance with the present invention;

FIG. 4 is a diagram illustrating the radios of FIG. 3 assigned to respective channels after a request has been received to initiate a voice call between radios RAD₁, RAD₂, and RAD₄;

FIG. 5 is a diagram illustrating the radios of FIG. 4 after the call between radios RAD₁, RAD₂, and RAD₄ has ended;

FIG. 6 is a diagram illustrating the radios of FIG. 5 assigned to respective channels after a request has been received to initiate a new voice call between radios RAD₁ and RAD₂;

FIG. 7 is a diagram illustrating the radios of FIG. 6 assigned to respective channels after a request has been received to initiate a new voice call between radios RAD₃ and RAD₄, with the conversation between radios RAD₁ and RAD₂ still ongoing;

FIG. 8 is a diagram illustrating the radios of FIG. 7 after the call between radios RAD₃ and RAD₄ has ended, and after the call between radios RAD₁ and RAD₂ has ended;

FIG. 9 is a flowchart illustrating methods of the present invention;

FIG. 10 is a high-level system diagram of a multi-site communication system that could be used to implement the systems and methods of the present invention.

### DETAILED DESCRIPTION OF ILLUSTRATED EMBODIMENTS

The invention relates to a trunking protocol for a multi-channel two-way radio communication network. As already described, known PRIOR ART digital trunking systems use either a scanning protocol, or a control channel protocol. The present invention uses a “parking channel” protocol, and may operate at various frequencies, including frequencies ranging from about 300 MHz to about 1200 MHz, and including specifically 800 MHz. In general, all radios in standby mode are parked at the then-existing parking channel. When a call is initiated, all called radios remain on that channel, which is then designated as an active voice channel for the requested conversation. All other radios are bumped to another available channel which becomes the new parking channel. When a call is completed, all radios from the call are assigned to the then-existing parking channel, or if no such channel exists, then the channel on which the call just completed becomes the new parking channel.

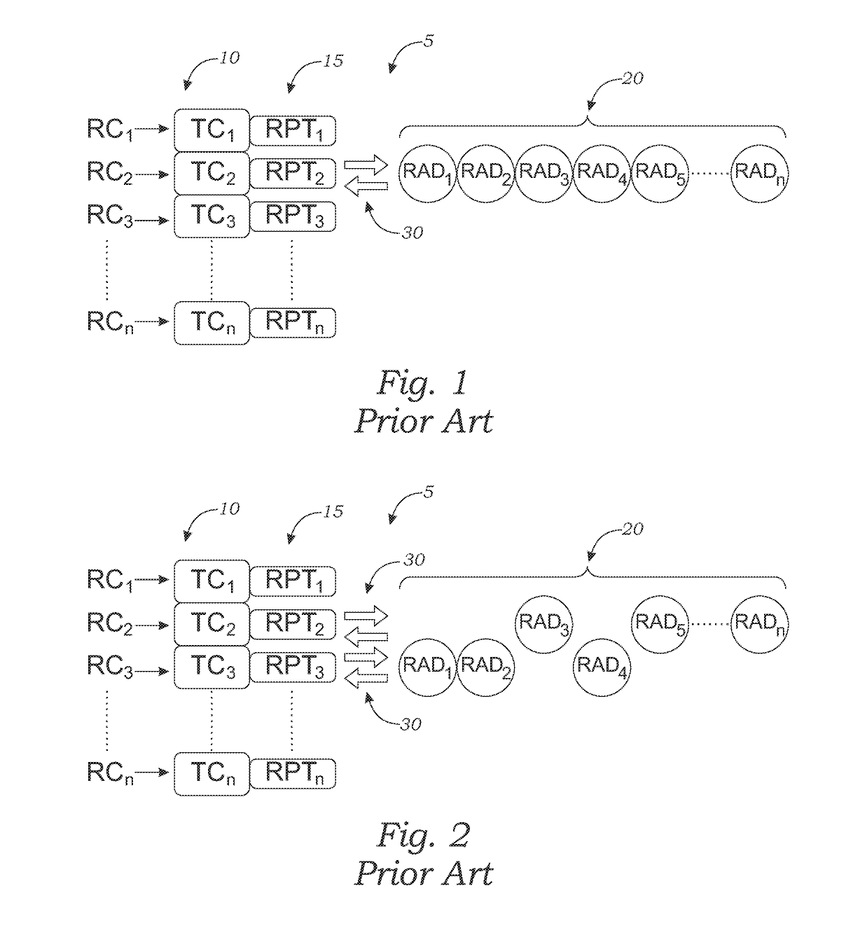

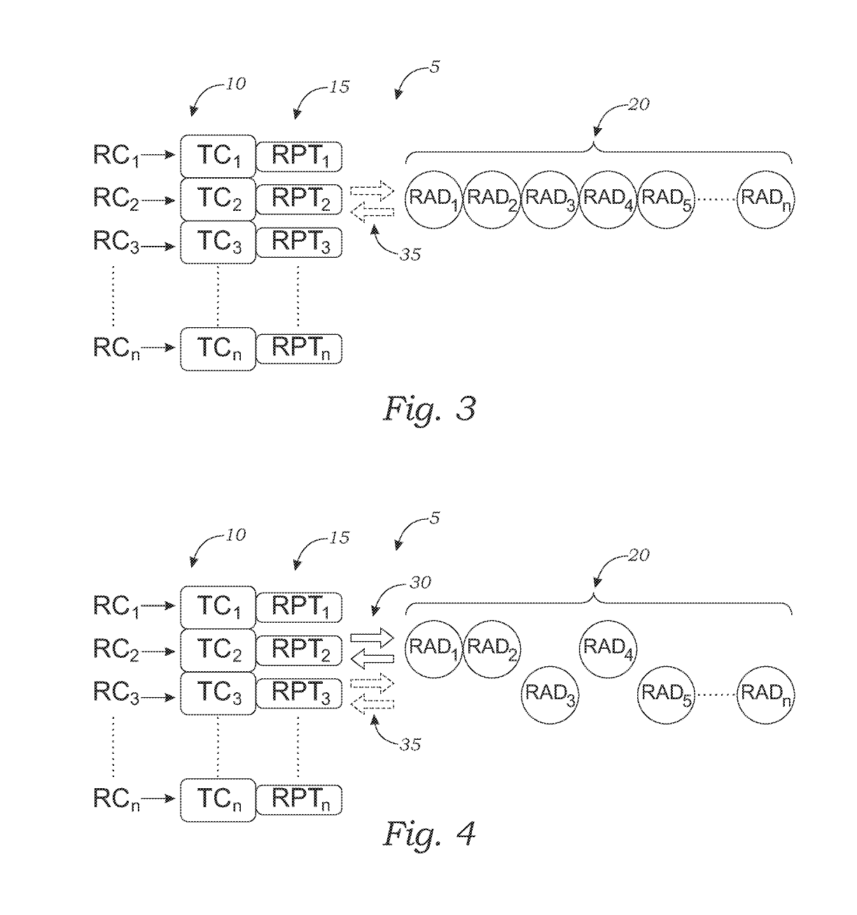

Turning now to FIG. 3, a diagram is shown illustrating radios 20 in standby mode as indicated by dashed arrows 35, in a communication system 5, using a trunking protocol with a parking channel in accordance with the present invention. Similar to the control channel protocol system (FIGS. 1-2), the trunking controllers 10 control the corresponding repeaters 15, with each trunking controller+repeater pair representing a repeater channel (RC₁, RC₂, RC₃, . . . RCₙ). But unlike the control channel protocol system, with the parking channel protocol system there is no repeater channel serving as a control channel. Instead, the channel where the standby radios are assigned (RC₂) is the initial parking channel. Thus, although the diagram in FIG. 3 looks similar to the diagram in FIG. 1, RC₂ in the parking channel protocol system (FIG. 3) is the parking channel (note the dashed arrows 35), whereas RC₂ in the control channel protocol system (FIG. 1) is the control channel (note the solid arrows 30).

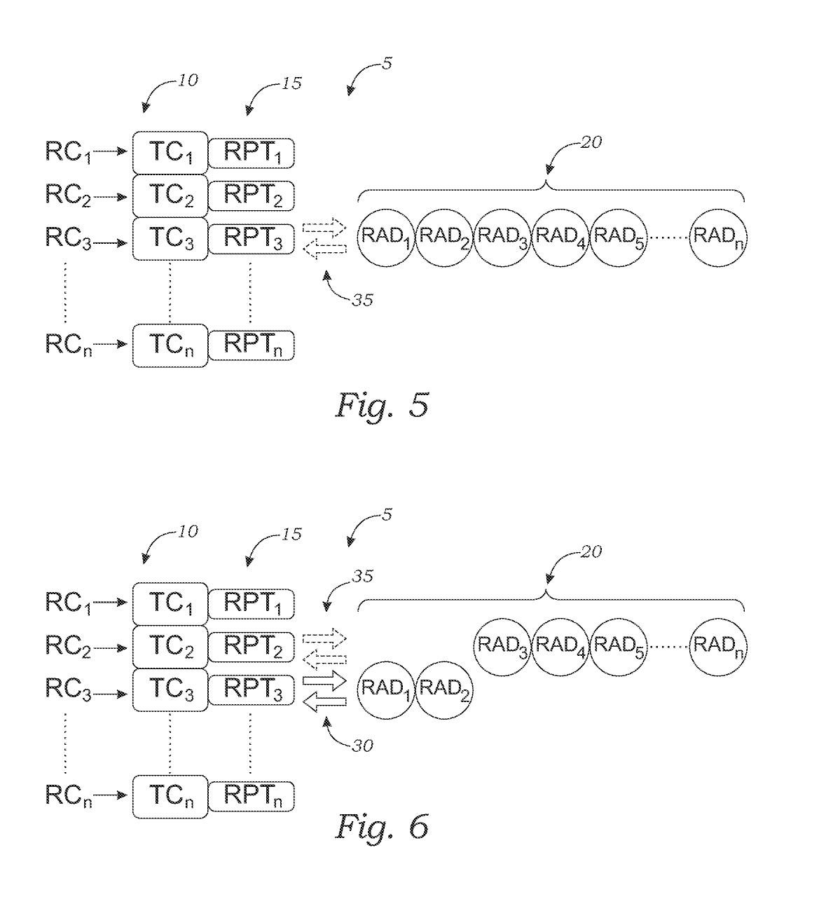

To illustrate how the parking channel protocol works, consider the radios 20 (RAD₁, RAD₂, RAD₃, RAD₄, RAD₅, . . . RADₙ) in FIG. 3. As stated, they are in standby mode and assigned to the parking channel RC₂. Standby mode means the receivers on the radios are ready to receive, but the transmitters are not active. If radio RAD₁ then requests to initiate a call with radios RAD₂, and RAD₄, the controller TC₂ for the then-existing parking channel RC₂ instructs all non-called radios (RAD₃, RAD₅, . . . RADₙ) to bump to a separate available channel (RC₃ in this example), which then serves as the new parking channel. The controller TC₂ then initiates the requested call between radios RAD₁, RAD₂, and RAD₄, on the previous parking channel RC₂. The previous parking channel RC₂ thus becomes an active voice channel for the requested conversation, and RC₃ becomes the new parking channel. The result is shown in FIG. 4. Continuing with the same example, once the call between radios RAD₁, RAD₂, and RAD₄ ends, those radios are placed in standby mode and assigned to the then-existing parking channel. Presuming no intervening calls, that channel would still be RC₃. The result is shown in FIG. 5, with all radios on standby being parked at parking channel RC₃.

In both the control channel protocol example (FIGS. 1-2), and the parking channel protocol example (FIGS. 3-5), both systems began having all radios 20 at channel RC₂. In both examples, radio RAD₁ then requested to initiate a call with radios RAD₂, and RAD₄, and there were no intervening calls. In both examples, the requested call then ended. However, in the control channel protocol example, the radios 20 all ended up being assigned back to channel RC₂ (the control channel), as seen in FIG. 2, whereas in the parking channel protocol example, the radios all ended up being assigned to channel RC₃ (the then-existing parking channel), as seen in FIG. 5. While all the actual benefits of the parking channel protocol of the present invention over the known control channel protocol may not be apparent from these simple examples, these examples nonetheless illustrate the difference in operation between the control channel protocol and the parking channel protocol. Actual benefits of the parking channel protocol of the present invention will be apparent to those of ordinary skill in this field, based on their experience combined with the teachings of this patent.

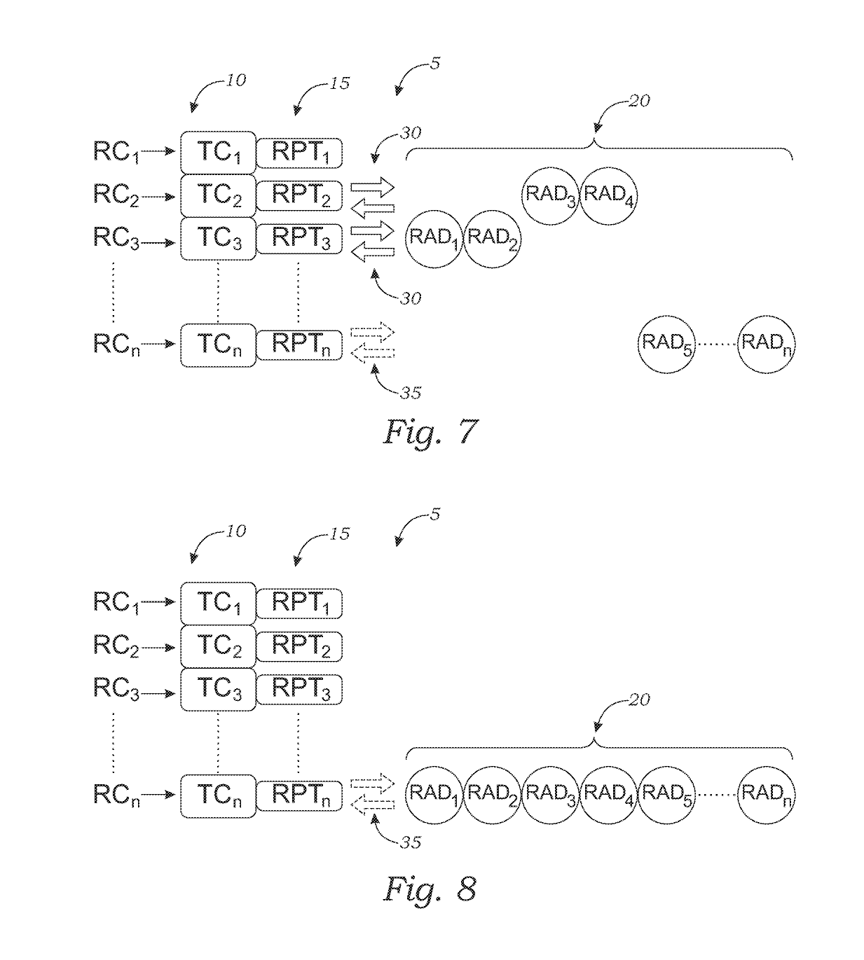

Continuing with the parking channel protocol example, and beginning with FIG. 5 where all radios 20 are in standby mode parked at parking channel RC₃, presume radio RAD₁ requests to initiate a call with radio RAD₂. Trunking controller TC₃ then designates RC₃ as an active voice channel for the conversation, and assigns radios RAD₃ through RADₙ to a new parking channel, e.g., RC₂. The result is shown in FIG. 6. If radio RAD₃ then requests to initiate a call with radio RAD₄, trunking controller TC₂ then designates channel RC₂ as an active voice channel for that conversation, and assigns radios RAD₅ through RADₙ to a free channel, such as channel RCₙ to act as the new parking channel. The result is shown in FIG. 7, showing a conversation on channel RC₃ (between radios RAD₁ and RAD₂) and a conversation on channel RC₂ (between radios RAD₃ and RAD₄), with radios RAD₅ through RADₙ remaining in standby mode on the then-current parking channel, RCₙ. When the conversations on channels RC₂ and RC₃ end, and presuming no intervening calls, the radios from those channels are assigned to the then-existing parking channel, RCₙ, to wait in standby mode with the other radios RAD₅ through RADₙ. The result is shown in FIG. 8, showing all radios RAD₁ through RADₙ parked at parking channel RCₙ in standby mode. The examples described with respect to FIGS. 3-8 show the basic principles of the parking channel protocol of the present invention.

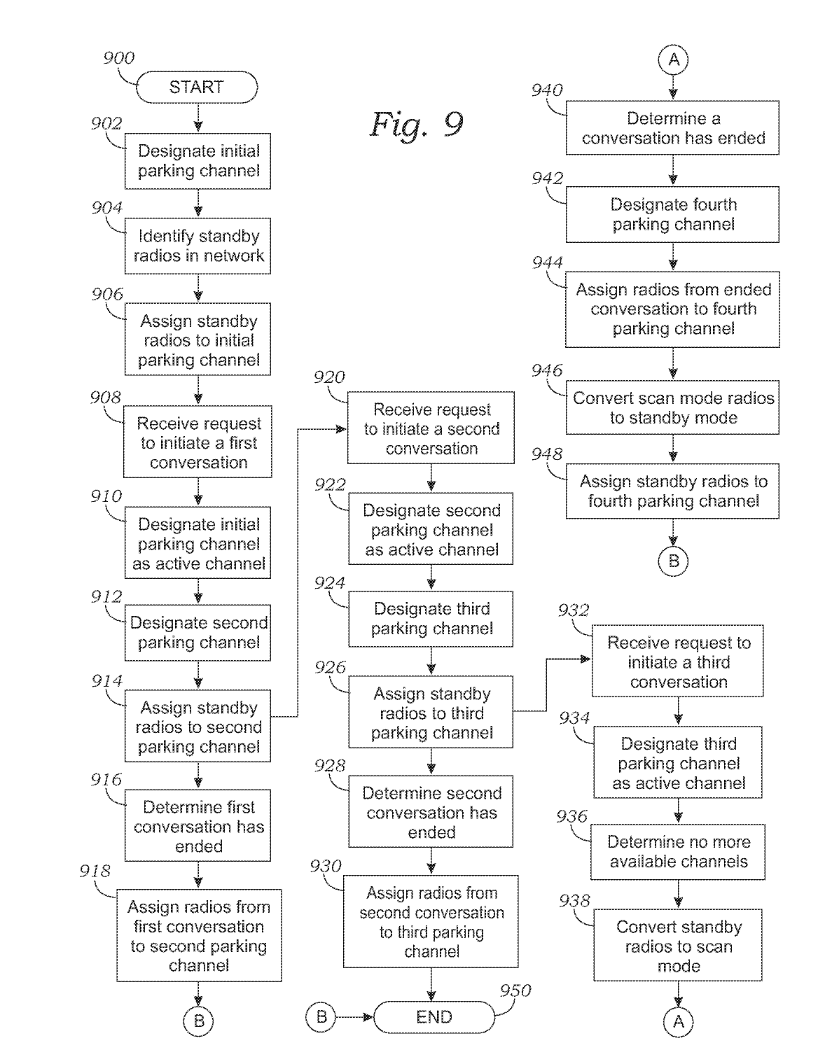

Turning now to FIG. 9, methods of using the parking channel protocol in a multi-channel two-way radio communication system will now be described in more detail. The description will correspond to the diagrams in FIGS. 3-8 as applicable, but for clarity the specific radios and components involved will not always be restated. The method begins at Step 900. At Step 902, an available channel in the network is designated as the parking channel. Once a parking channel is designated, no other channel will be a parking channel at the same time, except perhaps for an insignificant time during reassignment of channels. The algorithm for determining which available channel to select may vary. Some examples include random assignment, or next in sequential order. At Step 904, the two-way radios in the network are identified. Steps 902 and 904 may be performed substantially simultaneously, or in any order. The radios may be in scan mode initially, and if so they are converted to standby mode. This can be done using industry standard commands. All network radios in standby mode are then assigned to the parking channel at Step 906. This too may be done using industry standard commands and/or protocols. FIG. 3 is representative of the system state at this time.

At Step 908, a request is then received from one of the radios to initiate a voice conversation with one or more other radios in the network. The parking channel controller then designates the existing parking channel as an active voice channel for the requested conversation (Step 910), designates another available channel at that time to be the new parking channel (Step 912), and instructs all non-called radios to remain on standby and to move to the new parking channel (Step 914). These steps may occur substantially simultaneously, or in any order. For example, the new parking channel may be designated as such before or after the initial parking channel is designated as an active voice channel. FIG. 4 is representative of the system state at this time. When it is determined the conversation has ended (Step 916), the radios that participated in the ended call are then placed back in standby mode and assigned to the then-existing parking channel (Step 918). Presuming no intervening calls, that channel would be the same channel that was designated as the new parking channel upon initiation of the call. And in such as case, the method could then end as shown at Step 950. FIG. 5 is representative of the system state at this time.

The method will now be described in which there is an intervening call after the first call is initiated, but before the first call ends. For this description, the diagram in FIG. 5 will be used as the starting system state, i.e., with RC₃ as the parking channel. Here, the first call is initiated between radios RAD₁ and RAD₂, which remain on channel RC₃. Channel RC₂ is designated as the new parking channel, and accordingly radios RAD₃ through RADₙ are assigned to channel RC₂. This is reflected in the diagram of FIG. 6, and corresponds to Steps 900 through 914 as previously described, although in this example the first and second parking channels are channel RC₃ and channel RC₂ respectively. Now, instead of the first call ending at Step 916, the method continues from Step 914 to Step 920 wherein a request is received for a new conversation between some of the radios then on standby. The parking channel controller then designates the then-existing parking channel (e.g., RC₂ in FIG. 6), as an active voice channel for the requested conversation (Step 922), designates another available channel at that time (e.g., RCₙ in FIGS. 6-7) to be the new parking channel (Step 924), and instructs all non-called radios to remain on standby and to move to the new parking channel (Step 926). The system at this time corresponds to the diagram in FIG. 7.

When it is determined the second conversation has ended (Step 928), the radios that participated in the second call are then placed back in standby mode and assigned to the then-existing parking channel (Step 930). The method could then end as shown at Step 950. Instead of ending, however, the method may continue to a point wherein it is determined the first conversation has ended (Step 916), and the radios that participated in the first call may then likewise be placed back in standby mode and assigned to the then-existing parking channel. Of course, the same principles would apply if the first conversation ended before the second conversation ended. In either case, presuming no intervening calls between the start of the method, the initiation of the first and second calls, and the end of the first and second calls, that parking channel would be the same channel that was designated as the new parking channel at Step 924, i.e., after the second call was initiated. In such as case, the method could then end as shown at Step 950. The system at this time corresponds to the diagram in FIG. 8.

Still referring to FIG. 9, a new situation will now be described. Specifically, presume there are only three channels in the network, and two are in use for voice calls. The other is the parking channel. If another request for a voice call is received (e.g., Step 932), the parking channel is designated as an active voice channel to handle the requested conversation (Step 934). It is then determined there are no more available channels to act as the new parking channel (Step 936). In this situation, the radios in standby mode are all converted to scan mode (Step 938). They continue in scan mode until it is determined one of the conversations has ended (Step 940). This may be determined as is known in the art, for example, by scanning for a Call Collect Tone (CCT) from a channel that becomes available. Once this occurs, the available channel is free to serve as the parking channel, and the channel is designated as such (Step 942). The radios that were in scan mode are converted back to standby mode (Step 946), and assigned to the new parking channel (Step 948). Simultaneously (or shortly before or after), the radios from the just-ended call on that channel are assigned to the same channel which is now a parking channel (Step 944). This may occur by having those radios simply remain there in standby mode, or by those radios first being converted to scan mode, and then being assigned to the parking channel as part of Step 948 with the other radios that were then in scan mode from Step 938. The method then ends at Step 950.

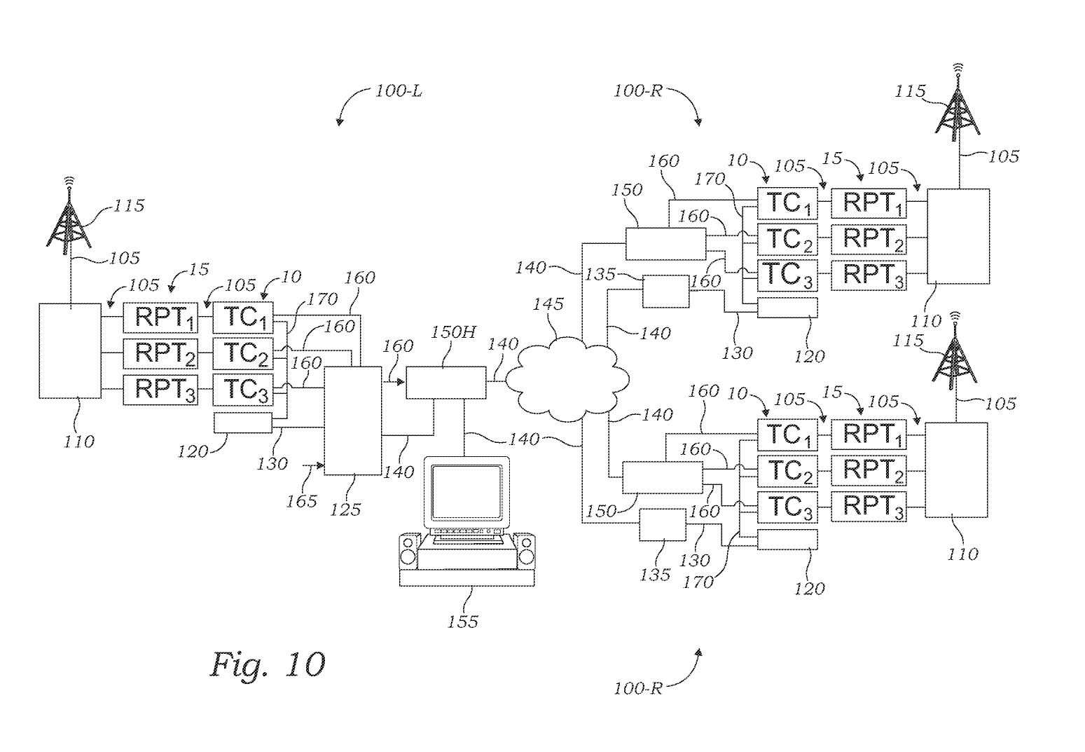

The methods described herein are carried out by a combination of software, hardware, and firmware, embedded in the trunking controllers, and used in combination with other hardware throughout the network. A typical wide area system is shown in FIG. 10, showing a local site 100-L and two remote sites 100-R. Each site 100 includes multiple trunking controllers 10 (e.g., SMARTRUNK ST-858 controllers) connected to each other via high-speed serial buses 170, which support the channel assignment protocols, and allow the trunking controllers 10 to share information such as the status of the radios and of the controllers 10, and to issue commands to each other. Each site 100 also has corresponding repeaters 15 for the trunking controllers 10. The trunking controllers 10 and repeaters 15 are connected to each other using standard repeater-controller connections 105. Each trunking controller 10 is programmed to be capable of carrying out the methods as described herein, and to serve as a parking channel controller. Each site has its own parking channel, which is known to the bridges 120.

The repeaters 15 at each site 100 are connected to corresponding combiner/multi-couplers 110, which in turn are connected to the corresponding antennae 115 at the site 100, all via similar standard connections 105. In addition, each site 100 has a modified trunking controller to act as a data bridge 120 between its corresponding controllers 10 and a network switch 125, such as a SMARTRUNK ST-310 or ST-510. The bridges 120 have special programming for such functions, and typically do not have RF capability as they are not used for active voice calls. Since the network switch 125 is at the local site 100-L, the bridge 120 at the local site 100-L is connected directly to the network switch 125 via an RS232 line 130. Likewise, the trunking controllers 10 at the local site 100-L are connected via two wire analog lines 160 directly to the network switch 125. The network switch 125 communicates with radios via two wire phone lines 165, and handles all data and voice communications between sites 100.

At the remote sites 100-R, the trunking controllers 10 are connected to the switch 125 indirectly through the network 145. The trunking controllers 10 are connected first to VoIP gateways 150 via two wire analog line connections 160 at the corresponding remote sites 100-R. The VoIP gateways 150 manage voice transmissions between controllers 10 and the network switch 125 over the network, and are connected via Ethernet connections 140 through the network 145 to the VoIP hub 150H at the local site 100-L, which in turn is connected to the switch 125. Likewise, the bridges 120 at remote sites 100-R are connected to the switch 125 indirectly via RS232 lines 130 to media converters 135, which in turn are connected via Ethernet connections 140 through the network 145 to the VoIP hub 150H, which is connected to the switch 125. A dispatch console/server 155 is also connected to the VoIP hub 150H at local site 100-L, to allow management and control of the network.

Still referring to FIG. 10, an example of how a dispatch call is handled will now be briefly described. First, a radio makes a dispatch call which may involve multiple radios at multiple sites. A trunking controller receives the call and validates the call is authorized. The bridge 120 is informed of the call, and the bridge 120 then redirects the call to the network switch 125. If the call involves a remote site 100-R (i.e., a site remote from the network switch 125), the voice data passes through an RS232 converter 135, over the network (e.g. Internet) 145, to the VoIP hub 150H and ultimately to the network switch 125. The switch 125 then retransmits the call request over the network to all bridges 120 in the system. The data passes over the network through RS232 converters 135 at the remote sites 100-R to the bridges 120 at the remote sites 100-R. The bridges 120 check to determine if the dispatched call should be established at their corresponding sites (i.e., the target radio has roaming at the site). If not, the call is discarded and the parking channel is not changed at the site 100. But if the call should be established, the call is transmitted to the parking channel, and the parking channel is then updated as discussed herein. The trunking controller 10 then transmits information to the bridge 120 as to the updated status of the controllers 10 at the site, and the bridge 120 then transmits the information to the switch 125 over the network. The switch 125 connects the voice inputs and establishes the audio paths for the call to take place.

Some benefits of the parking channel protocol over existing protocols will now be described. One benefit is the target channel for called radios may be acquired much faster than if the radios had to be bumped out of the control channel to a separate available channel for the conversation, as would be done in a control channel protocol system. For example, access time in a parking channel protocol system ranges from 0.35 seconds to 0.50 seconds, compared to approximately 1.20 seconds for typical digital system, and 2.00 seconds for a typical analog system. The reduced acquisition time is possible because the parking channel is used as a ready-to-go voice channel, so when a call is requested the called radios are already on the target channel. The conversation can start as soon as a user activates the hardware, for example using Push-To-Talk (for dispatch) or ID Code+* sign (for mobile to mobile calls). There is no need of a long call collect tone header through all the channels in the system, but only a single header which signals the called radios to remain on the channel, and a short excluding string for the non-called radios, forcing them to jump to the new parking channel, which will typically be randomly determined to minimize the risk of system failure in case a repeater channel is damaged or otherwise out of service.

Another benefit of the parking channel protocol over the control channel protocol is an increased efficiency in the number of available channels. Since there is no need to designate a control channel, the system is able to use all channels for voice calls if needed. In systems with a relatively small number of channels, the increase in efficiency can be substantial. For example, in a system with four channels, a control channel protocol would be able to use only three of the channels for voice calls, whereas the parking channel protocol would be able to use all four, resulting in a 33% increase in efficiency. Likewise, in a system with ten channels, the increase in efficiency would be more than 11%, and even in a system with fifteen channels, the increase in efficiency would be almost 7%.

Another benefit of the parking channel protocol is compared to the scanning protocol. With a scanning protocol, radios are always scanning, and thus cannot be operated in power-save mode without risking operational functionality. But with the parking channel protocol, radios generally are not scanning, so the radios can operate in power-save mode to extend the battery life. Doing so will reduce the power demand of trunked radios, as well as the average operating temperature. For example, in power-save mode the duty cycle may be altered and have only a 0.010 second delay. Control channel protocol trunking systems cannot effectively do this, because the radio receiver must always be on to allow the radios to receive data. Likewise, analog systems cannot do this because the radios must be on to detect the Call Collect Tone (CCT).

Other benefits to using the parking channel protocol will be apparent to those of ordinary skill in this field, based on their experience combined with the teachings of this patent. For example, many governments require special licensing for control channel protocol systems, which can be very expensive and may not even be available. But those same governments likely would not require such licenses for parking channel protocol systems. Also, the repeater hardware for control channel systems must typically be 100% duty cycle to be available to act as a control channel in the event of a control channel failure, and thus such repeaters are more expensive than repeaters for a parking channel protocol. Likewise, circulators and combiners used in a parking channel protocol system will generally be less expensive than those used in a control channel protocol system. The foregoing benefits are thus merely exemplary and are not meant to be a complete list.

Systems and methods have thus been described for a new trunking protocol known as a parking channel protocol. Certain benefits of the parking channel protocol have also been described.

What is claimed is:

1. A method of using a multi-channel two-way radio communication network comprising:
designating a first available channel in the network to be a first parking channel;
identifying a plurality of two-way radios in the network that are in standby mode, said plurality of two-way radios comprising a first radio, a second radio, and additional radios;
assigning the plurality of two-way radios in standby mode to the first parking channel;
receiving a first request from the first radio to initiate a first conversation between the first radio and the second radio;
designating the first parking channel as a first active voice channel for the first conversation, after receiving the first request;
designating a second available channel in the network to be a second parking channel, after receiving the first request; and
assigning the additional radios in standby mode to the second parking channel.

2. The method of claim 1, wherein the second available channel in the network is designated to be the second parking channel after the first parking channel is designated as the first active voice channel.

3. The method of claim 1, further comprising determining the first conversation has ended, and then assigning the first radio and the second radio to the second parking channel.

4. The method of claim 1, wherein the additional radios comprise a third radio, a fourth radio, and other additional radios, the method further comprising:
receiving a second request from the third radio to initiate a second conversation between the third radio and the fourth radio;
designating the second parking channel as a second active voice channel for the second conversation, after receiving the second request;
designating a third available channel in the network to be a third parking channel, after receiving the second request; and
assigning the other additional radios in standby mode to the third parking channel.

5. The method of claim 4, further comprising determining the first conversation has ended, and then assigning the first radio and the second radio to the third parking channel.

6. The method of claim 5, further comprising determining the second conversation has ended, and then assigning the third radio and the fourth radio to the third parking channel.

7. The method of claim 4, further comprising determining the second conversation has ended, and then assigning the third radio and the fourth radio to the third parking channel.

8. The method of claim 4, wherein the other additional radios comprise a fifth radio, a sixth radio, and remaining radios, the method further comprising:
receiving a third request from the fifth radio to initiate a third conversation between the fifth radio and the sixth radio;
designating the third parking channel as a third active voice channel for the third conversation, after receiving the third request;
determining there are no more available channels in the network to be used as a parking channel, after receiving the third request; and
converting the remaining radios in standby mode from standby mode to scan mode to allow the remaining radios to scan for an available channel.

9. The method of claim 8, further comprising:
determining at least one of the first, second, and third conversations has ended, thus allowing the corresponding channel from the ended conversation to become a newly-available channel;
designating the newly-available channel as a fourth parking channel;
assigning the radios from the ended conversation to the fourth parking channel;
converting the remaining radios in scan mode from scan mode to standby mode; and
assigning the remaining radios in standby mode to the fourth parking channel.

10. A trunking system for a multi-channel two-way radio communication network comprising:
a plurality of repeaters; and
a plurality of trunking controllers;
wherein each one of the plurality of trunking controllers is connected to a corresponding one of the plurality of repeaters to form a corresponding plurality of repeater channels;
wherein each of the plurality of trunking controllers is connected to each other via a serial bus; and
wherein each of the plurality of trunking controllers is programmed to serve as a parking channel capable of:
designating a first available channel in the network to be a first parking channel;
identifying two-way radios in the network that are in standby mode, said two-way radios comprising a first radio, a second radio, and additional radios;
assigning the two-way radios in standby mode to the first parking channel;
receiving a first request from the first radio for a first conversation between the first radio and the second radio;
designating the first parking channel as a first active voice channel for the first conversation, after receiving the first request;
designating a second available channel in the network to be a second parking channel, after receiving the first request; and
assigning the additional radios in standby mode to the second parking channel.

11. The system of claim 10, wherein each of the plurality of trunking controllers is further programmed to be capable of designating the second available channel in the network to be the second parking channel after the first parking channel is designated as the first active voice channel.

12. The system of claim 11, wherein each of the plurality of trunking controllers is further programmed to be capable of determining the first conversation has ended, and then assigning the first radio and the second radio to the second parking channel.

13. The system of claim 10, wherein the additional radios comprise a third radio, a fourth radio, and other additional radios, and wherein each of the plurality of trunking controllers is further programmed to be capable of:
receiving a second request from the third radio to initiate a second conversation between the third radio and the fourth radio;
designating the second parking channel as a second active voice channel for the second conversation, after receiving the second request;
designating a third available channel in the network to be a third parking channel, after receiving the second request; and
assigning the other additional radios in standby mode to the third parking channel.

14. The system of claim 13, wherein each of the plurality of trunking controllers is further programmed to be capable of determining the first conversation has ended, and then assigning the first radio and the second radio to the third parking channel.

15. The system of claim 14, wherein each of the plurality of trunking controllers is further programmed to be capable of determining the second conversation has ended, and then assigning the third radio and the fourth radio to the third parking channel.

16. The system of claim 13, wherein the other additional radios comprise a fifth radio, a sixth radio, and remaining radios, and wherein each of the plurality of trunking controllers is further programmed to be capable of:
receiving a third request from the fifth radio to initiate a third conversation between the fifth radio and the sixth radio;
designating the third parking channel as a third active voice channel for the third conversation, after receiving the third request;
determining there are no more available channels in the network to be used as a parking channel, after receiving the third request; and
converting the remaining radios in standby mode from standby mode to scan mode to allow the remaining radios to scan for an available channel.

17. The system of claim 16, wherein each of the plurality of trunking controllers is further programmed to be capable of:
determining at least one of the first, second, and third conversations has ended, thus allowing the corresponding channel from the ended conversation to become a newly-available channel;
designating the newly-available channel as a fourth parking channel;
assigning the radios from the ended conversation to the fourth parking channel;
converting the remaining radios in scan mode from scan mode to standby mode; and
assigning the remaining radios in standby mode to the fourth parking channel.
